(19) United States
(12) Patent Application Publication
(10) Pub. No.: US 2025/0016824 A1
(43) Pub. Date: Jan. 9, 2025

(54) AN OPTICAL WIRELESS COMMUNICATION SYSTEM

(71) Applicant: SIGNIFY HOLDING B.V., EINDHOVEN (NL)

(72) Inventors: ANDRIES VAN WAGENINGEN, Wijlre (NL); MATTHIAS WENDT, Würselen (DE); NANCY YUSHAN LEE, EINDHOVEN (NL); ROBERT JAMES DAVIES, EINDHOVEN (NL)

(21) Appl. No.: 18/701,960

(22) PCT Filed: Oct. 11, 2022
(86) PCT No.: PCT/EP2022/078235

§ 371 Date: Apr. 17, 2024

(30) Foreign Application Priority Data
Oct. 18, 2021 (EP) 21203132.2

(51) Int. Cl. H04W 74/06; H04B 10/116; H04W 84/12

(52) U.S. Cl. CPC H04W 74/06; H04B 10/116; H04W 84/12

(57) ABSTRACT

An optical communications access point, AP (AP), is provided, and a system combining the AP and additional stations, STAs, (STA1, STA2) which are in communications range of the AP over a communications medium of an optical wireless local area network. The AP is arranged to, before sending downlink poll messages, send an invite to poll message inviting STAs (STA1, STA2) to send a request to poll message within an invite-to-poll time window. The AP (AP) then sends a downlink poll message to a first identified STA (STA1) having requested a poll, thereby allowing a return uplink transmission for a predetermined duration to be initiated by the first STA (STA1) after receiving the first downlink poll message. The first downlink poll message prohibits other STAs, (STA2) receiving the first downlink poll message, from accessing the communications medium during said predetermined duration after the first downlink poll message. The AP in this manner is able to take control of communications to mitigate uplink collisions, especially in the case of heavy uplink traffic, and reduce the use of a physical carrier sense for uplink access.

### FIELD OF THE INVENTION

This invention relates to optical wireless communication systems, as well as an optical communication access point and optical communication stations for use therein and a method of optical wireless communication between such access points and stations.

### BACKGROUND OF THE INVENTION

LiFi (Light Fidelity) is a new type of Optical Wireless Communication (OWC), which also includes Visible Light Communication (VLC). OWC (and hence LiFi and VLC) use light as a media of communication, for replacing cable wire (wireline) communication.

Light based communication offers the ability for high data rate communication, for example even exceeding 10 Gbit/s, for devices having a line of sight between them. This for example applies to a set of communicating devices within an office environment.

Known LiFi products rely on a grid of optical access points mounted in the ceiling. The beams of these access points are wide enough (and thereby have a large field of view and/or coverage area) to create an overlap with the neighboring access points at the level of the desks beneath. The receiving devices in such a system are typically located at the desks or are being held by hand at a height close thereto.

For ease of installation, the grid of access points is for example aligned with the luminaire grid in the ceiling. Each access point in such an installation must reach (illuminate, in the case of visible light) several square meters and hence illuminates a significant conical area. Such installations may utilize illumination light for the downlink (to the end devices) and may use invisible light (e.g. infrared or ultraviolet) for the uplink (towards the access point) so as not to disturb mobile device users. Alternatively, both downlink and uplink may utilize invisible light thereby at least partially or fully disentangling the lighting and communication infrastructure.

To communicate with the access points, currently a dongle is connected to a user device such as a laptop or tablet. These dongles also emit a similar broad beam to be sure that at least one access point will receive the signal from the dongle. The beams of the access points and the dongles are fixed in direction, so no adjustment of the beam direction is required.

Each access point comprises a modem connected to one or multiple optical transceivers. The end devices (e.g., laptop with dongle) connect to the access point via an optical link and they also comprise a modem connected to one or multiple transceivers.

The function of the modem is to handle the protocols (modulate and demodulate) for transmitting and receiving data over the visible or invisible light connection. The modem transmitter includes an optical frontend which transforms an electrical signal of the transmit data to an optical signal (for example using an LED) and the modem receiver transforms the optical signal to an electrical receive data signal (using a photodiode).

As is clear from the discussion above, LiFi end devices have a limited field of view. When a carrier sense multiple access (CSMA) scheme is used (for example as specified by IEEE 802.11), collisions occur due to the limited visibility of other end devices that are nearby. By lacking information about the channel medium occupancy of the other transceivers, the CSMA protocol degrades to ALOHA.

An option to address this issue is to apply a request to send and clear to send approach (RTS/CTS). The request to send message is sent from the transceiver to the access point whereas the clear to send message sent by the access point and is received by all transceivers. In 802.11, it carries duration information and the transceivers will then set their network allocation vector (NAV) to indicate that the medium is busy according to this duration information.

A disadvantage of the RTS/CTS scheme is that it adds extra overhead. If the data frame to transmit is small, such overhead does not make sense. If a frame is larger than a threshold, then a transceiver will send an RTS message before sending the frame. The default value for this threshold is large: 2347 bytes.

It has been proposed to set the default value to a smaller value, such that association frames and all handshake frames can just pass. In this way, the use of more RTS messages allows the network to recover from collisions, at the expense of more latency in the network due to the increased use of the medium for the RTS messages. Performance can be optimized by setting the threshold.

However, even if the threshold setting for RTS/CTS is fully explored, situations may occur that are unwanted.

If the traffic demand is very high, the threshold may be set very low leading to many RTS/CTS occurrences. In the absence of a working clear channel assessment, the many RTS frames will also suffer from collisions. Thus, although RTS/CTS may be a good protection mechanism to prevent a collapse of the throughput, it still has drawbacks for a LiFi system.

It would be desirable to be able to address this issue in a backward compatible manner, for example compatible with existing versions of IEEE802.11, such as IEEE802.11n or IEEE802.11ac, and which can be implemented with minimal changes that can be realized in software.

United States patent application 2019/0335254 A1 discloses a method of optical wireless communication that includes sending, by a first device in a wireless network, a poll packet for polling a second device in the wireless network. The poll packet includes an address of the second device. The second device receives and at least partially decodes the poll packet. The second device sends a response packet in response to the poll packet. The sending of at least part of the response packet is substantially simultaneous with the receiving of at least part of the poll packet by the second device.

### SUMMARY OF THE INVENTION

The invention is defined by the claims.

According to examples in accordance with an aspect of the invention, there is provided an optical communications access point, AP, for communicating with stations, STAs, which are in communications range of the AP over a communications medium of an optical wireless local area network, wherein the STAs are configured to wait to receive a poll message before being permitted to send an uplink transmission,
wherein the AP is adapted to:
   send a first downlink poll message to a first identified STA thereby to allow a return uplink transmission for a predetermined duration to be initiated by the first STA after receiving the first downlink poll message,
wherein the first downlink poll message also prohibits other STAs, receiving the first downlink poll message, from accessing the communications medium during said predetermined duration after the first downlink poll message.

This AP is able to take control of communications to mitigate uplink collisions, especially in the case of heavy uplink traffic. It reduces the use of a physical carrier sense for uplink access. In particular, restrictions are placed on the STAs (which are in particular the end devices, EDs with which the AP communicates) for attempting to access the communications medium based on a physical carrier sense. Only one identified (i.e. selected) STA can initiate a return uplink message while the downlink poll message is sent. The identified STA will initiate a return uplink message if it has data to transmit, otherwise other receiving devices can be polled.

Preferably, the access point may also be adapted to, before sending the first downlink poll message, send an invite to poll message inviting STAs to send a request to poll message within a time window.

When a large number of STAs are associated with an AP, the polling cycle could be lengthy. If STAs have long queues of data but most have nothing, the polling cycles could result in a long overhead. This is addressed by having an ‘invite to poll’ period during which STAs that have data to send can request a poll from the AP. The invite to poll signal indicates that the AP is preparing to poll the STAs and it declares a time interval (the invite-to-poll time window) during which the STAs can send a request to poll signal.

An STA, when configured to operate in this manner, no longer takes the initiative to access the communications medium (i.e. the physical layer of the communications channel) once it is associated to the AP. Instead, it waits to be polled. The STA may then only access the medium directly after the AP has finished its downlink transmission (or has received the invite-to-poll).

The AP thus has full control over its associated STAs.

The predetermined duration may be a default duration or it may be specified in the first downlink poll message.

The wireless local area network is for example implemented according to IEEE 802.11 or a similar protocol, but in accordance with the invention, a polling mechanism is implemented on top thereof. Specifically, the invention relates to a system with medium access based on carrier-sense multiple access with collision avoidance whereby equipment listens to a channel for other users before transmitting each frame. In the context of IEEE 802.11, the default behavior of a STA is thus to attempt to gain access by physical carrier sensing. This default behavior is changed to enable the AP to control the access by polling.

The access point is for example adapted to prevent STAs newly within range of the AP from associating with the AP during periods of network overload, and wherein the AP is adapted to identify network overload based on at least one one of:
the level of network activity;
the time duration for uplink messages;
waiting times for uplink messages.

In this way, a new STA is blocked during overload and the STA will not try to take any initiative to access the communications medium at all, even for association. The AP thus has full control over the STAs. Heavy traffic may cause network overload for example in the case of half-duplex LiFi.

The access point is for example adapted to send a further downlink poll message to a second, different, identified STA to allow a return uplink transmission from that second STA in the absence of an initiated uplink message from the first STA.

The access point may include information in the invite to poll message that limits permission to send a request to poll message to a subset of STAs. This can reduce the likelihood of collisions between request to poll messages from multiple STAs. The invite to poll message may also contain other information (e.g. STA characteristics) that might prioritize some STAs over others for a given cycle. Thus, the number of STAs eligible to respond to a given downlink poll message can be limited to a subset of STAs.

The AP may also be configured to selectively block new STAs from associating with the AP, for example during periods of overload. An STA is then prohibited from taking any initiative to access the medium at all, even not for association.

The invention also provides an optical communications station, STA, for communicating with an optical communications access point, AP, over a communications medium of an optical wireless local area network,
wherein the STA is adapted to:
   be configured to wait to receive a poll message before being permitted to send an uplink transmission;
   receive from the AP a first downlink poll message uniquely identifying the STA;
   determine if a return uplink transmission is needed to the AP;
   if a return uplink transmission is needed:
      initiating a return uplink transmission immediately after the downlink poll message; and
      providing the return uplink transmission within a predetermined duration after receiving the first downlink poll message,
wherein the STA is configured to be prohibited from accessing the communications medium during said predetermined duration after a downlink poll message which identifies a different STA.

The STA is prohibited from accessing the medium when other STAs are being polled, and equivalently, when the STA is receiving the first downlink poll message, other STAs receiving the first downlink poll message are prohibited from accessing the communications medium (during said predetermined duration after the first downlink poll message).

Preferably, in situations where the AP uses an invite-to-poll mechanism, the STA is adapted to be configured to wait to receive an invite to poll message or a poll message before being permitted to send an uplink transmission;

When the STA receives the invite to poll message from the AP, the STA, in response thereto, when the STA has an amount of data to be transmitted greater than a first threshold, sends one or more request to poll messages which include an identification of the STA during the invite-to-poll time window. In this manner the STA can indicate whether or not it requires polling, yet leaves control at the AP.

As mentioned above, in the context of IEEE 802.11, the default behavior of a STA is to attempt to gain access by physical carrier sensing. This default behavior may be configurable, and may be switched from a carrier sensing mode of operation to a polling mode of operation, so as to enable the AP to control the channel access by means of a polling mechanism. Thus, the STA may only support a basic access mechanism that relies on physical carrier sensing, but can be configured to wait on accessing the medium until it is addressed by the AP to do so.

The wireless local area network is preferably again implemented according to IEEE 802.11, but further includes the above described polling mechanism for initiating uplink traffic, so the channel access is otherwise according to IEEE 802.11.

The STA may be preconfigured, for example hardcoded, to operate in the polling mode of operation, as the default configuration. Alternatively the STA may be preconfigured to operate using the conventional carrier sense mode of operation, and may be re-configured to operate using the polling mode of operation. Reconfiguration may be achieved in a variety of ways. Reconfiguration may be achieved using manual configuration on the device by means of its user interface, or alternatively by means of using a remote user interface and a wired network link or NFC link in a manner akin to configuring a Wi-Fi access point. More alternatively the configuration may be changed by means of an in-band mechanism, whereby the STA changes its mode of operation based on an instruction from an AP, during or subsequent to the association process. Finally, instead of configuring the STA in a mode of operation whereby it waits to receive a poll message as a default mode of operation, the STA may be instructed by the AP to wait to receive a poll message on a case by case basis.

The STA may also be configurable to be prohibited from associating with an AP. This configuration may be implemented based on receipt of a suitable indication from the AP.

The invention also provides an optical communication system comprising: the access point as defined above; and a set of one or more STAs each as defined above.

In such system when the AP uses an invite-to-poll mechanism, it may occur that in response to an invite to poll message, a STA having an amount of data to be transmitted greater than a first threshold is adapted to send one or more request to poll messages which include an identification of the STA during the time window, and
the AP then sends a downlink poll message to one of the responding STAs to allow a return uplink transmission from that STA.

The STA desiring a poll thus identifies itself to the AP. The use of multiple request to poll messages from one STA can be used to address collision of a single request to poll message with other request to poll messages from other STAs.

The AP may be adapted to send a further downlink poll message to a second, different responding STA to allow a return uplink transmission from that second STA after the duration allocated to the first STA expires. The request to poll message may indicate a requested duration of the return uplink transmission.

The STA can thus indicate how much data it intends to transmit in the uplink message.

The AP is for example then adapted to allocate a time period for the return uplink transmission which is longer than the requested duration of the return uplink transmission, thereby blocking other STAs from accessing the communications channel immediately after the return uplink transmission and allowing the AP to seize the channel to transmit downlink data or to send another downlink poll message or to send another invite to poll message.

In this way, the AP can take control of the channel for the portion of the time period which exceeds the requested duration. The AP manipulates the virtual carrier sense to give itself priority access to the medium. The AP allocates a longer duration value than the STA actually needs in each frame and medium access is also blocked for other STAs.

Instead of the AP padding the duration of the return uplink transmission, the AP can use the PCF interframe spacing, PIFS, for the wait time (which is less than the DCF interframe spacing, DIFS, that the end devices must wait) after end of a transmission opportunity. In this way, the AP has priority to gain access to the medium. Thus, the AP is allowed to use the PIFS after any polled return uplink transmission.

The STAs may be adapted to send a request to poll message with a random backoff. This reduces collisions between the request to poll messages.

In response to an invite to poll message, a STA having an amount of data to be transmitted less than a second threshold may be adapted to send the amount of data in place of a request to poll message. Thus, if a message of similar size to a request to poll message is to be sent, there is no point using the request to poll system, and the message can simply be sent.

The AP may be adapted to select the time window duration granted for return uplink transmissions based on current network conditions.

The AP is adapted to select one or more STAs to which downlink poll messages are to be sent based on the request to poll messages. Thus, the request to poll messages are processed to determine the required downlink poll messages.

The invention also provides an optical communications method for communicating between an optical communications access point, AP, and stations, STAs, of users which are in communications range of the AP over a communications medium of an optical wireless local area network, wherein the method comprises:
configuring the STAs to wait to receive a poll message before being permitted to send an uplink transmission;
controlling the AP to send a first downlink poll message to a first identified STA to allow a return uplink transmission for a specified duration to be initiated only by the specific identified STA immediately after the downlink poll message.

Other STAs are thereby prohibited from accessing the communications medium during said specified duration.

The method is computer-implemented.

The method preferably comprises
before sending the first downlink poll message, controlling the AP to send an invite to poll message inviting STAs to send a request to poll message within a time window; and
in response to the invite to poll message, controlling a STA having an amount of data to be transmitted greater than a first threshold to send one or more request to poll messages which include an identification of the STA during the time window.

The AP is for example adapted to transmit information about its use of the communications medium to other APs or to a global system controller, to facilitate coordination between APs with overlapping coverage areas.

The invention also provides a computer program comprising computer program code means which is adapted, when said program is run on a processor or processors of the optical communications system defined above to implement the method as also defined above.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a typical configuration of a LiFi system;

FIG. 2 illustrates the problem for uplink communication from multiple STAs to an AP;

FIG. 3 shows a first example of communication method;

FIG. 4 shows an enhancement to the method of FIG. 3; and

FIG. 5 shows another communication method.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an optical communications access point, AP, and a system combining the AP and additional stations, STAs, which are in communications range of the AP over a communications medium of an optical wireless local area network. The AP sends a downlink poll message to a first identified STA thereby to allow a return uplink transmission for a predetermined duration to be initiated by the first STA after receiving the first downlink poll message. The first downlink poll message prohibits other STAs, receiving the first downlink poll message, from accessing the communications medium during said predetermined duration after the first downlink poll message. The AP is able to take control of communications to mitigate uplink collisions, especially in the case of heavy uplink traffic, and it reduces the use of a physical carrier sense for uplink access.

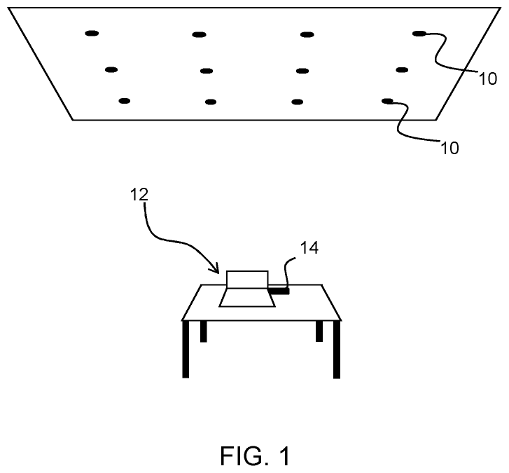

FIG. 1 shows a typical LiFi system with a set of access points, AP, 10 forming a ceiling mounted infrastructure and a LiFi STA implemented by a dongle 14 attached to a mobile device such as a laptop 12. The combination of units 12 and 14 is an end device (also known as an end point). The access points are preferably linked to a backbone, e.g. by means of a wired link such as an Ethernet link using a twisted pair cable or an Optical Fiber network allowing the access points and/or a global system controller to align, e.g. on handover.

Each AP contains a modem connected to one or multiple LiFi STAs. The end device STAs can connect to an AP via an optical link. Each STA also contains a modem connected to one or multiple LiFi transceivers. The function of the LiFi-modem is to handle the physical layer (PHY) and media access control layer (MAC) protocols for transmitting and receiving data over the visible or invisible light connection.

The LiFi transceiver comprises a transmitter to transform an electrical signal of the modem's transmit data to an optical signal (e.g. via an LED, a VCSEL or laser diode) and to provide a receiver to transform an optical signal to an electrical of the modem's receive data (e.g. via a photodiode). The end device STA is for example implemented by a dongle 14 attached to a mobile device such as a laptop. Instead of retro-fitting, it is envisaged that the receiver functionality is ideally integrated with the user receiving devices themselves, in this manner laptops, tablets, mobile phones and/or other devices may use optical communication without the need for a dongle.

The LiFi system uses the medium access mechanisms of IEEE 802.11 for an optical wireless local area network. In this specification, a distributed coordination function applies channel assessment, CA, using carrier sense multiple access, CSMA. A random backoff count is used following a busy condition. Physical and virtual carrier sense functions are used to determine the state of the communications medium. When either function indicates a busy medium, the medium shall be considered busy; otherwise, it shall be considered idle.

The physical carrier sense mechanism is based on a clear channel assessment, CCA, and a virtual carrier sense mechanism is based on duration reservation.

An option to provide the duration information is by means of a request to send, RTS, and clear to send, CTS, mechanism. A station that receives duration information sets its network allocation vector accordingly. This maintains a prediction of future traffic based on the duration information. When a STA determines that the medium is idle and remains idle for a period of the Distributed Coordination Function (DCF) Inter Frame Space, DIFS, and its backoff counter is zero, it may transmit.

For a LiFi system in which the nodes apply CSMA such as specified by IEEE 802.11, collisions occur due to the limited visibility of nodes that are nearby. By lacking information about the occupancy of the communications medium by the other nodes, the CSMA protocol degrades to ALOHA.

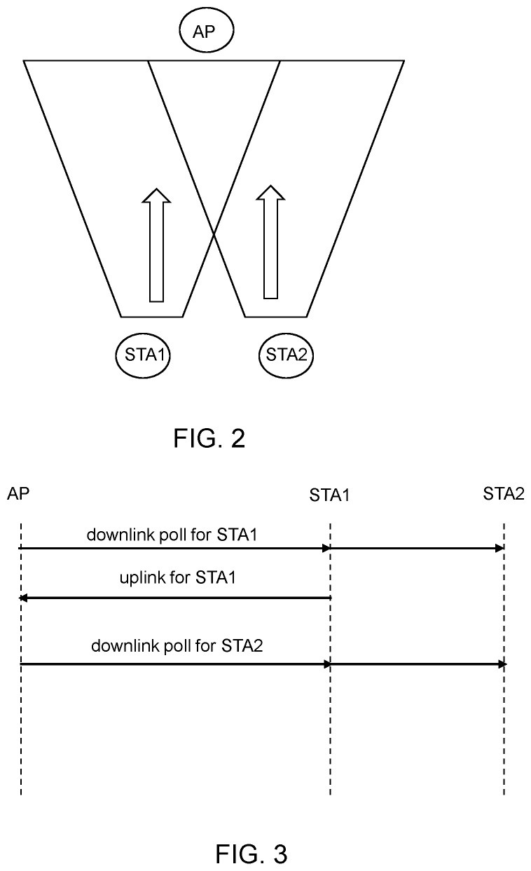

FIG. 2 illustrates the problem for uplink communication from multiple STAs (STA1 and STA2) to an AP. Since each STA has a line-of sight connect to the AP with a limited view angle, STA1 cannot detect the activity of STA2 and vice versa.

A first option to address this problem is by applying a request to send and clear to send, RTS/CTS, scheme.

For example, STA1 in FIG. 2 wants to transmit, it first transmits an RTS. The AP then responds with a CTS. STA2 will not receive the RTS but will receive the CTS carrying the duration information and will set its network allocation vector (NAV) indicating the communications medium to be busy according to this duration information.

The disadvantage of the RTS/CTS scheme is that it adds extra overhead. If the data frame to transmit is small, such overhead does not make sense.

If a frame is larger than a threshold, then a STA (other than the AP, which is also generally defines to a station) shall send an RTS message before sending the frame. The default value for threshold is large: 2347 bytes. Algorithms exist to optimize performance by setting this threshold. For example, the RTS threshold should increase as the number of nodes decreases or the data rate grows.

Even if the threshold setting for RTS/CTS is fully explored, situations may occur that are unwanted. In particular, if the traffic demand is very high, the threshold may be set very low leading to many RTS/CTS occurrences. In the absence of a working clear channel assessment, the many RTS frames will also suffer from collisions. Thus, although the RTS/CTS scheme may be a good protection mechanism to prevent a collapse of the throughput, it is insufficient for a LiFi system.

An enhanced access mechanism may solve this problem based on later versions of IEEE 802.11 such as IEEE802.11ax. This provides orthogonal frequency division multiple access, OFDMA, allowing the AP to allocate resource unit, RUs, for uplink access. However, this implementation is not suitable for low-end STAs like Internet of Things, IOT, devices.

Similarly, the 802.11 Hybrid coordination function Controlled Channel Access (HCCA) feature of 802.11 enables a LiFi AP to function as a Hybrid Controller (HC) using a Hybrid Coordination Function (HCF) controlled channel access mechanism. The HC grants a Service Period (SP) of one or more transmission opportunities, TXOPs. These are intervals of time during which a particular quality-of-service STA has the right to initiate frame exchange sequences onto the communications medium. This is again a complex feature not suitable for low-end STAs like Internet of Things, IOT, devices.

The invention instead is compatible with simpler implementations of IEEE802.11 without OFDMA or HCCA, and may be implemented using changes that can be realized in software.

The invention provides a scheme by which an AP is given additional options to mitigate uplink collisions, especially in the case of heavy uplink traffic, by reducing the use of physical carrier sensing for uplink access.

FIG. 3 shows a first example of communication method. The method is for communicating between an optical communications access point, AP, and stations, STAs, of users which are in communications range of the AP over a communications medium of an optical wireless local area network.

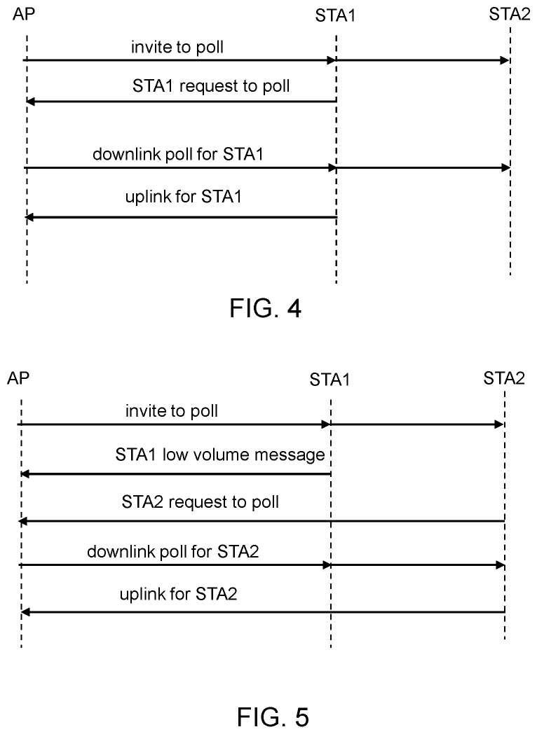

Before the start of the method as shown in FIG. 3 (and indeed FIGS. 4 and 5), the STAs are configured to wait to receive a poll message before being permitted to send an uplink transmission.

The STAs in the communications system of the invention wait for a poll and hence will not try to access the communications medium on their own initiative. Existing STAs thus need to be modified such that they wait for a poll, preferably with minimal adaptation.

A simple approach is to to configure these STAs differently for OWC than for RF communication. For RF communication, they may take the initiative to gain access to the communications medium, whereas for OWC they do not take the initiative but wait for a poll. Such configuration may be hardcoded in the end device.

Another option is that the AP indicates to an end device that it shall wait for being polled (and forbids it to take initiative). The AP may indicate this during association as a condition to become part of the basic service set (BSS). The AP may indicate this after association to (e.g. temporarily) forbid the device to take initiative.

The STA may thus be configured to wait to receive a poll message by hardcoding as the standard configuration for a OWC mode; or by instruction by the AP. For the latter case, a dedicated indication may be provided by the AP for example in a CTS message from the AP. The AP may indicate for which message types an end device is allowed to take the initiative to communicate and for which message types it is not allowed (e.g. allowed to take access initiative for small messages, for control messages, etc.).

The AP sends a first downlink poll message (“downlink poll for STA1”) to a first identified station STA1 to allow a return uplink transmission for a specified duration to be initiated by the specific identified station STA1 immediately after the downlink poll message. The specified duration may be a default duration or it may be specified in the first downlink poll message.

The return uplink message is initiated during the downlight poll message and is completed within the specified duration. The uplink message is shown as “uplink for STA1”.

During the specified duration, other STAs such as STA2 are prohibited from accessing the communications medium. As shown the station STA2 does receive the downlink poll for STA1 but does not respond to it.

The AP sends a further downlink poll message to the second station STA2 (“downlink poll for STA2”) to allow a return uplink transmission from that second STA after the duration allocated to the first STA expires.

In the example of FIG. 3, the station STA2 does not have any data to send in an uplink message, so it does not reply. The downlink poll for STA2 is received by both stations STA1, STA2, but the first station STA1 is not allowed to respond. The downlink poll message thus includes the identity of the specified STA.

This approach puts restrictions on the STAs for attempting to access the medium based on physical carrier sensing. Virtual carrier sensing (i.e. allocating time periods to different STAs) is used to indicate channel busy to other STAs.

The modification to the standard carrier sensing approach may be implemented via configuration, for example an IEEE802.11 chip may be software configured differently for LiFi than for WiFi but may also be implemented in a protocol between AP and STA, whereby the AP imposes the reduction of physical carrier sensing to the STAs.

By this approach, a STA which is associated with the AP shall not take the initiative to access the communications medium once it is associated to the AP; it shall instead wait for the AP to poll the STA by addressing the STA with the downlink poll transmission. A STA may only access the medium directly after the AP has finished its downlink transmission to the STA. Other STAs that are not addressed shall not try to access the medium. If the STA does not initiate an uplink transmission within the DCF Inter Frame Space, DIFS, idle time after the end of the downlink transmission, the AP interprets this as meaning the STA has no data to transmit and initiates a downlink transmission to a different STA.

With this option, the AP has full control over its associated STAs. This functionality may be implemented by configuration of all STAs, or by defining an AP signal indicating that the STAs have to obey to this option. The AP may also apply this option to selected STAs, for example those STAs that do not support a more advanced access mechanism, like low-cost IOT devices.

FIG. 4 shows an enhancement. When a large number of STAs are associated with an AP, the polling cycle could be lengthy. In conditions where a fraction of STAs have long queues of data but most have nothing, the polling cycles could result in an overhead perhaps comparable to that of the RTS/CTS scheme.

In mitigation, the AP can signal an “invite to poll” message as shown in FIG. 4, setting a time period in which STAs that have data to send can request a poll from the AP. The invite to poll signal indicates that the AP is ready to poll STAs.

The invite to poll declares at least a time interval during which STAs can send a request to poll signal.

FIG. 4 shows that the invite to poll is sent to all associated STAs. In the example shown, only STA1 replies, because STA2 has no data to send.

The invite to poll may also contain other information (e.g., STA characteristics) that might prioritize some STAs over others for a given cycle or that might request the STA to include certain information in any request to poll message that it returns.

During the time window of the invite to poll, STAs with data to send may send a request to poll message that contains at least the identity of the STA and, possibly, auxiliary information like the amount of data to send, a priority level and so on. The required data in the request to poll is for example specified in the invite to poll message.

During the time window of the invite to poll message, request to poll messages are sent in Aloha-like fashion using a random back-off. When the invite to poll time window closes, the AP selects from the request to poll messages it has received those STAs that it will poll in the manner shown in FIG. 3.

The choice of time window for the invite to poll and auxiliary information may be determined by the AP according to the current network conditions. For example, if the AP becomes aware that collisions in the time window for the invite to poll are preventing request to poll messages from being heard, it may increase the time window duration for subsequent cycles or may include priority information that limits the STAs that can issue request to poll messages.

Collisions can occur even when traffic is light so, in these circumstances, a STA may be allowed to issue a request to poll message more than once during the time window of the invite to poll message.

This approach differs from a normal RTS/CTS mechanism because the AP is allowed to collect request to poll messages and decide for itself which STAs to poll. It thus retains full control over its STAs.

FIG. 5 shows a variant in which STAs that have a small amount of data to send that falls below the current RTS/CTS threshold (or a threshold set in the invite to poll message) may opt to send it directly in place of an request to poll message, accepting the risk of collision.

Thus, in FIG. 4, STA1 responds to the invite to poll with a “STA1 low volume message”. STA2 instead replies with a request to poll. A downlink poll and uplink message then follow for STA2 in the same way as shown in FIG. 3.

An additional option is to block new STAs during an overload period. In this case, a STA shall not try to take any initiative to access the medium at all, even not for association. This may be implemented by the AP temporarily blocking new STAs by forbidding STAs to associate. If the situation relaxes, the AP may end this restriction and re-allow STAs to associate again. The AP again has full control over all STAs. This may be implemented by indication from the AP.

The method for blocking associated STAs from accessing the medium (i.e. prohibiting uplink communication until there is a poll) may be different from the method for blocking unassociated STAs from accessing the medium (i.e. forbidding association).

The AP can determine when a network is overloaded. An AP may for example assess an overload situation by considering following indications.
Indication 1: The medium is fully occupied-The AP detects no inactivity on the medium over some period of time.
Indication 2: Many STAs consume the maximum allowed duration time for uplink transmission. The AP may set such maximum duration for each uplink access.
Indication 3: Advanced STAs report long queues of data waiting for transmission.
Indication 4: The throughput falls dramatically while any of the previous indications applies.

The AP thereby monitors the communications medium access and may, depending on the situation, for example based on the frequency of detected uplink collisions, choose an appropriate option to reduce the physical carrier sense by the STAs.

Another additional option is for the AP to manipulate the virtual carrier sense to give itself priority access to the medium. In this case, an associated STA is only allowed to occupy the communications medium for less time than is indicated by the duration field.

In the request to poll message, the STA can for example indicate how much data it intends to transmit in the uplink message and hence a required uplink message duration. The AP cam then allocate a time period for the return uplink transmission which is longer than the requested duration of the return uplink transmission, thereby blocking unassociated STAs from accessing the communications channel immediately after the return uplink transmission and allowing the AP to seize the channel to transmit downlink data or to send another downlink poll message.

In this way, the AP can take control of the channel for the portion of the time period which exceeds the requested duration. The AP manipulates the virtual carrier sense to give itself priority access to the medium. The AP allocates a longer duration value than the STA actually needs in each frame and medium access is also blocked for other STAs.

This blocks communications medium access by other STAs. The AP can take control over the medium before the network allocation vector at other STAs expires, by starting transmission immediately after the transmitting STA finishes its uplink activity. Once the AP has access to the medium, it can either transmit downlink data or it can send a polling signal to grant access to a specific STA.

There are various options for implementing the signaling required by the methods described above. The signaling can be implemented as minimal extensions of existing 802.11 signaling and thus are straightforward to realize in software.

For example the downlink poll message may be implemented by using the existing clear to send, CTS, control frame (9.3.1.3 of 802.11-2020) in a new way, whereby the AP may trigger a particular STA by transmitting a CTS frame with the receiver address, RA, field set to the MAC address of the STA that is being polled and the Duration/ID field set to some fixed value.

If the STA has any data waiting in its queue(s), it shall immediately start transmitting after a clear to send, CTS, reception indicating its address. From then on existing rules apply; i.e. the first data frame sent by the AP contains duration information to indicate busy for the next fragment (if any) plus the acknowledgement frame.

The invite to poll message (FIG. 4) can be sent using a variant of the CTS message; likewise, the request to poll message can be implemented as a variant of the RTS message.

The invention provides an access point that functions in the manner above, a station (end point) that functions in the manner above, as well as an overall system. The invention also provides the communications methods as explained above.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. An optical communications access point, AP, for communicating with stations, STAs, which are in communications range of the AP over a communications medium of an optical wireless local area network, wherein the STAs are configured to wait to receive a poll message before being permitted to send an uplink transmission, wherein the AP is adapted to:
send a first downlink poll message to a first identified STA thereby to allow a return uplink transmission for a predetermined duration to be initiated by the first STA after receiving the first downlink poll message,
wherein the first downlink poll message also prohibits other STAs, receiving the first downlink poll message, from accessing the communications medium during said predetermined duration after the first downlink poll message,
the access point characterized in that it is adapted to:
before sending the first downlink poll message, send an invite to poll message inviting STAs to send a request to poll message within an invite-to-poll time window.

2. The access point of claim 1, wherein the predetermined duration is a default duration or specified in the first downlink poll message.

3. The access point of claim 1, adapted to prevent STAs newly within range of the AP from associating with the AP during periods of network overload, and wherein the AP is adapted to identify network overload based on at least one of:
the level of network activity;
the time duration for uplink messages;
waiting times for uplink messages.

4. The access point of claim 1, adapted to send a further downlink poll message to a second, different, identified STA to allow a return uplink transmission from that second STA in the absence of an initiated uplink message from the first STA.

5. The access point of claim 1, adapted to include information in the invite to poll message that limits permission to send a request to poll message to a subset of STAs of the optical wireless local area network.

6. An optical communications station, STA, for communicating with an optical communications access point, AP, over a communications medium of an optical wireless local area network, wherein the STA is adapted to:
be configured to wait to receive an invite to poll message or a poll message before being permitted to send an uplink transmission;
receive from the AP an invite to poll message and to in response thereto, when the STA has an amount of data to be transmitted greater than a first threshold, send one or more request to poll messages which include an identification of the STA during the invite-to-poll time window;
receive from the AP a first downlink poll message uniquely identifying the STA;
determine if a return uplink transmission is needed to the AP;
if a return uplink transmission is needed:
initiating a return uplink transmission during the downlink poll message; and
providing the return uplink transmission within a predetermined duration after receiving the first downlink poll message, and
wherein the STA is configured to be prohibited from accessing the communications medium during said predetermined duration after a downlink poll message which identifies a different STA.

7. The optical communications station of claim 6, wherein the STA is configured to wait to receive a poll message by:
hardcoding a wait-to-receive-a-poll-message mode as a default mode of operation for accessing the channel;
user or network operator configuration of the STA to the wait-to-receive-a-poll-message mode of operation;
receipt of an instruction from the AP to set the STA to the wait-to-receive-a-poll-message mode of operation; or
receipt of an instruction from the AP to wait to receive a poll message.

8. An optical wireless communication system comprising:
the access point, AP, of claim 1; and
a set of one or more optical communications stations, STAs,
wherein the AP upon receipt of one or more request to poll messages sends a downlink poll message to one of the responding STAs to allow a return uplink transmission from that STA.

9. The optical communications system of claim 8, wherein the AP is adapted to send a further downlink poll message to a second, different responding STA to allow a return uplink transmission from that second STA after the duration allocated to the first STA expires.

10. The optical communications system of claim 8, wherein the request to poll message indicates a requested duration of the return uplink transmission.

11. The optical communications system of claim 8, wherein in response to an invite to poll message, a STA having an amount of data to be transmitted less than a second threshold is adapted to send the amount of data in place of a request to poll message.

12. The optical communications system of claim 9, wherein the AP is adapted to select the time window duration granted for return uplink transmissions based on current network conditions.

13. The optical communications system of claim 9, wherein the AP s adapted to select one or more STAs to which downlink poll messages are to be sent based on the request to poll messages.

14. An optical communications method for communicating between an optical communications access point, AP, and stations, STAs, of users which are in communications range of the AP over a communications medium of an optical wireless local area network, wherein the method comprises:
configuring the STAs to wait to receive a poll message before being permitted to send an uplink transmission;
controlling the AP to send a first downlink poll message to a first identified STA to allow a return uplink transmission for a specified duration to be initiated only by the specific identified STA immediately after the downlink poll message;
the optical communications method comprises:
before sending the first downlink poll message, controlling the AP to send an invite to poll message inviting STAs to send a request to poll message within an invite-to-poll time window; and
in response to the invite to poll message, controlling an STA having an amount of data to be transmitted greater than a first threshold to send one or more request to poll messages which include an identification of the STA during the invite-to-poll time window.
